(19) United States
(12) Patent Application Publication
(10) Pub. No.: US 2014/0156444 A1
(43) Pub. Date: Jun. 5, 2014

(54) CONSUMER DRIVEN PRICE LOCAL MARKETPLACE

(71) Applicants: Andrey Yruski, San Francisco, CA (US); Lidia Yruski, San Francisco, CA (US)

(72) Inventors: Andrey Yruski, San Francisco, CA (US); Lidia Yruski, San Francisco, CA (US)

(21) Appl. No.: 14/095,837

(22) Filed: Dec. 3, 2013

Related U.S. Application Data
(60) Provisional application No. 61/797,212, filed on Dec. 3, 2012.

(51) Int. Cl. G06Q 30/06

(52) U.S. Cl. CPC G06Q 30/0611
USPC 705/26.4

(57) ABSTRACT

The invention is a method of allowing merchants and service providers to dynamically maintain their inventory and accept consumer offers on demand. Consumers have the ability to “name their price” for deals at local establishments.

### CROSS REFERENCE TO RELATED APPLICATIONS

This patent application claims priority to and the benefit of U.S. Provisional Patent Application Ser. No. 61/797,212 filed Dec. 3, 2012 entitled, “Consumer Driven Price Local Marketplace”, and the specification and claims thereof are incorporated herein by reference.

### BACKGROUND

1. Field of the Invention

Embodiments of the present invention are related to systems and methods for dynamically maintaining a merchant inventory to accept consumer offers on demand.

2. Description of the Related Art

Embodiments of the present invention allow merchants and service providers to dynamically maintain their inventory and accept consumer offers on demand.

Merchants can post offers on ChiChing® local with regular recommended prices allowing the consumers to name the price they are comfortable with. The merchant has full control to accept consumer offers in any time.

### SUMMARY OF THE CLAIMED INVENTION

One embodiment of the present invention includes a method of offering a user a good or service within a local region. They method includes allowing a user to select a physical region on a map, providing the user a list of establishments offering deals within the physical region, allowing a user to offer a price for a predetermined local deal offered at the establishments, notifying the establishments in real-time of the offered price for the predetermined local deal, and an establishment accepting the user's offered price for the predetermined local deal.

Further scope of applicability of the present invention will be set forth in part in the detailed description to follow, taken in conjunction with the accompanying drawings, and in part will become apparent to those skilled in the art upon examination of the following, or may be learned by practice of the invention. The objects and advantages of the invention may be realized and attained by means of the instrumentalities and combinations particularly pointed out in the appended claims.

### BRIEF DESCRIPTION OF THE DRAWINGS

The accompanying drawings, which are incorporated into and form a part of the specification, illustrate one or more embodiments of the present invention and, together with the description, serve to explain the principles of the invention. The drawings are only for the purpose of illustrating one or more preferred embodiments of the invention and are not to be construed as limiting the invention. In the drawings:

FIG. 1 shows an exemplary view of a map with locations of restaurants;

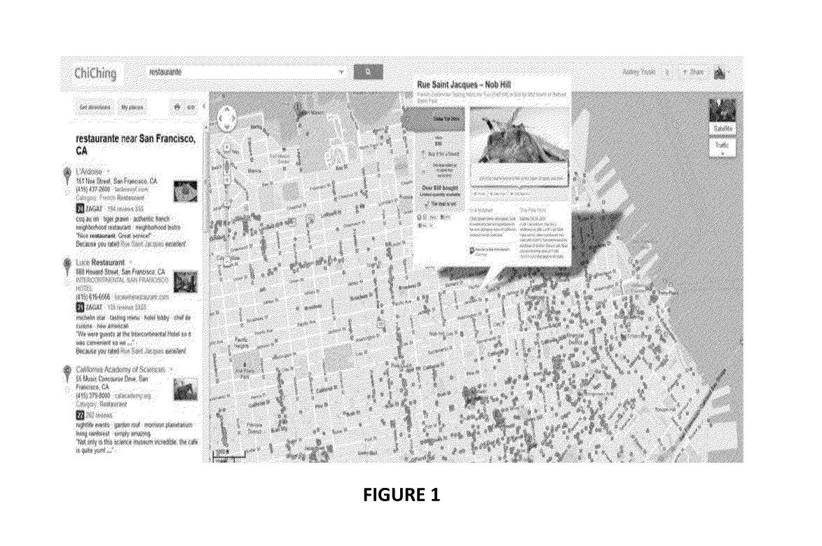

FIG. 2 shows an exemplary view of a listing of restaurants posting deals;

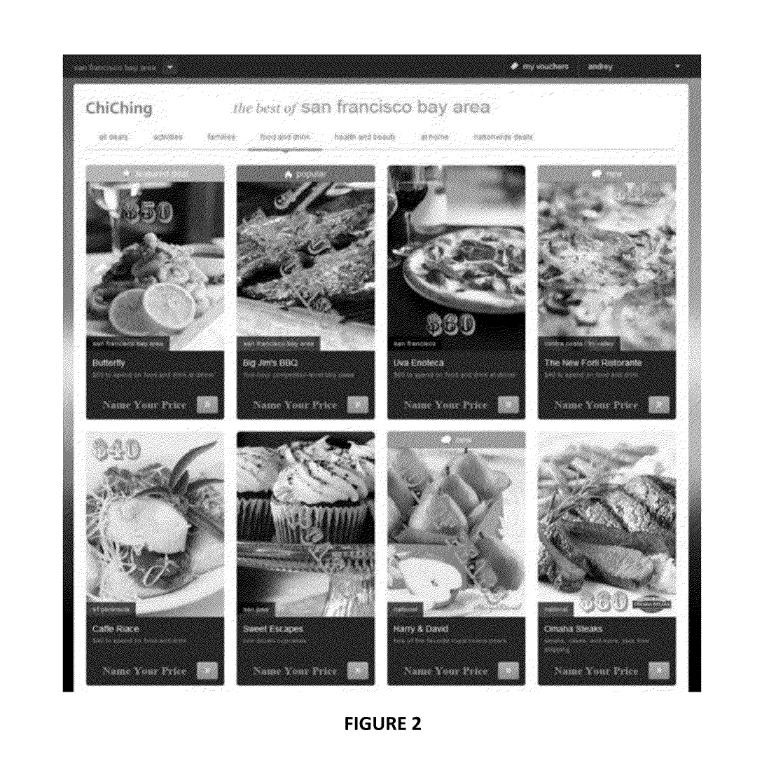

FIG. 3 shows an exemplary view of a user interface for creating a new deal; and

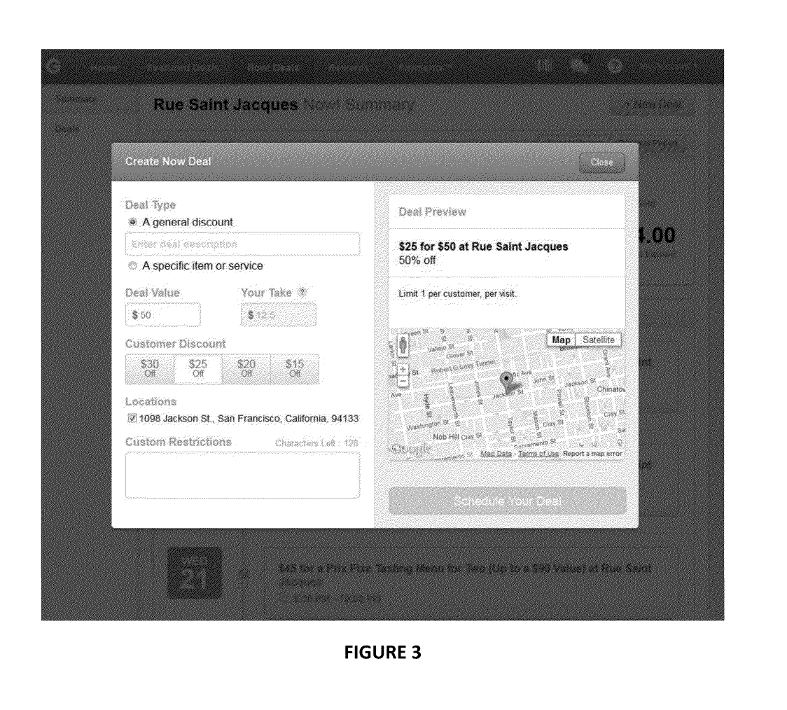

FIG. 4 shows an exemplary view of a webpage showing items that have shipped.

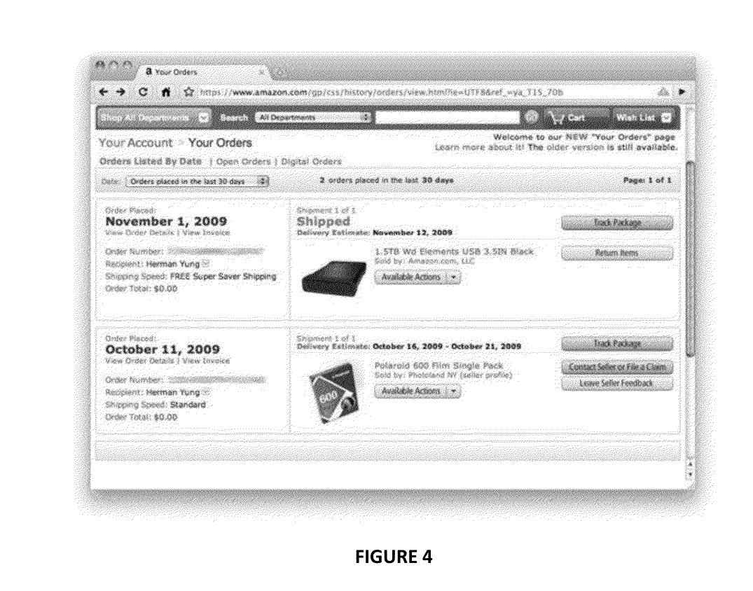

### DETAILED DESCRIPTION

Embodiments of the present invention allow restaurant owners to post their deals and the regular store price for the offer. Offer examples:
5 course meal worth $80 a person.->name your price
Tuesday special, $100 for food and wine. Tuesday only.->name your price
$100 off for weekday reservation.->name your price

The restaurant owner can add restrictions and limitations for the offers such, good for and Monday-Wednesday.

As most of the local deal sites, ChiChing® local allows the user to browse through the local deals as a list and/or a map view.

Per each restaurant offer a consumer can “name the price” for the offer such, $40 for a $100 food at Rue Saint Jacques restaurant. The consumer also specifies the period that the offer is good for (till date).

Each restaurant owner has an account on ChiChing® local where they can browse, sort, filter and see the consumer offers posted against the restaurant postings. The restaurant owner can accept the consumer offers. When a consumer offer been accepted the consumer's account/credit card is being charge with the “name your price” price and a deal certification is sent by email to the consumer. Once a consumer visit the restaurant with the deal certification the restaurant scans or types the deal certification number to the system, and only then ChiChing® local log a payment back to the restaurant.

A restaurant owner can set notifications upon consumer offer submission. Filters, limits and other rules for notifications could be set as well.

“Catch me if you can”, is the ability for the consumer to select a physical location on the map or a zip code and the acceptable distance, type/s of restaurant/cuisine, recommendations star indicator e.g. 4 starts and up and pick a generic deal such eating today/tomorrow/Saturday, time range, $100 worth of food for . . . ->name your price. This offer will be fed/notify in real-time to all the restaurants that match the criteria. The first restaurant to accept the consumers offer wins the deal. Similar deals could be, “4 course, no wine”, “open buffet”, etc.

The advantage over coupons is ChiChing® local dynamic nature, a merchant doesn't have to decide ahead of time the acceptable price. On a good day/week when the restaurant is full the restaurant owner could be less aggressive with accepting lower prices, however on low days/weeks a restaurant owner can take a real-rime decisions and accept lower prices to keep the business running. The advantages for the consumer are obvious.

An embodiment of the present invention includes a similar concept applied for attractions/adventures, escapes (travel), events, etc.

“Consumer Dollar Voucher” (“Catch me if you can”)

In general a voucher is a bucket/list of businesses that the consumer is interested in naming their price for a Dollar Voucher with a specific real dollar value. For instance for restaurant a, b, c, and d I offer $25 for a $50 Dollar Voucher.

The business list can be creates as:
1. Manually (novice, one or few mouse clicks) pick a business and make a Dollar Voucher Offer.
2. Manually adding business/s by browsing and selecting them from a list or a map. For instance a consumer can pick 8 of his favorite restaurants and add them to the list.
3. Selecting type of business or restaurant cuisine an address or point on the map with a specific radios or a zip code. All the businesses that match the criteria will be added to the list. The consumer has the option to go and edit the list, remove or add businesses as above.

The bucket/list is not limited to one type of business for a Dollar Voucher. The consumer can mix different businesses. For instance restaurant a, b, wine tasting, kart racing, $50 for a $110 Dollar Voucher.

Once the consumer approves the offer the offer added to the offer/deal list. The offer list indicates open offers, accepted offers, canceled offers, completed offers, etc . . . similar to Amazon “Your Orders”, where the user can see the status, edit and cancel offers.

Once a business accepted the offer belongs to a bucket/list, the consumer's offer gets removed from the rest of the businesses. So there will not be a case where you have more than a one business accepted the Consumer Dollar Voucher.

Each voucher has reasonable expiration day, for example, 30 days.

On top of that the consumer can browse through businesses (list or map) and see the “Business Proposition”s offers provided by the businesses.

### “Business Proposition Voucher”

In this case the business post offers similar to coupons on their ChiChing information page such as.
1. 5 course meal worth $80 a person.
2. Tuesday special, $100 for food and wine.
3. $100 off for weekday reservation.
4. Romantic dinner for 2 worth $90.
5. Winery Tour for Up to Eight with Two Bottles of Champagne, $765 value.
6. Cruise for Two in Sausalito, $80 value.
7. Teeth Whitening, $500 value.

A consumer browsing through the Businesses and Propositions, and offer their prices for the Business Proposition. The Business Proposition voucher/deal is added to the offer/deal list as the Consumer Dollar Voucher.

Business Proposition Voucher structured in a way that a consumer is able to multi-select businesses offering similar propositions and group them to a bucket/list similar to the Consumer Dollar Voucher.

### Business Rules and Automation

The business owner can access the real-time portal, where they can see the list of active consumer offers and accept the proposed consumer offers.

The consumer offer list could be filtered and sort as a combination of:
1. Filter/sort all the offers with a discount rate above X percentage. For instance show offers with 40% discount and below, $70 voucher for $35 (50%), $100 voucher for $60 (40%), Dinner for two with bottle of wine worth $140 for $70 (50%), etc . . .
2. Filter/sort all the offers above/below a fixed $ value. For instance, all the consumer's offers above $25.
3. Filter/sort all the offers above/below a fixed $ worth value. For instance, all the offers worth bellow $150.

The business owner can set rules to automate offer acceptance such:
1. Accept no more than 12 offers a day.
2. Accept no more than 9 offers, good for today only.
3. Accept offers with 40% discount and below.
4. Accept offers above $20 and below 50% discount.

The system first accepts offers that generate more revenue with less discount.

### Gift

All vouchers are transferable and could be provided as a gift without specifying the purchase price.

While various embodiments have been described above, it should be understood that they have been presented by way of example only, and not limitation. The descriptions are not intended to limit the scope of the invention to the particular forms set forth herein. Thus, the breadth and scope of a preferred embodiment should not be limited by any of the above-described exemplary embodiments. It should be understood that the above description is illustrative and not restrictive. To the contrary, the present descriptions are intended to cover such alternatives, modifications, and equivalents as may be included within the spirit and scope of the invention as defined by the appended claims and otherwise appreciated by one of ordinary skill in the art. The scope of the invention should, therefore, be determined not with reference to the above description, but instead should be determined with reference to the appended claims along with their full scope of equivalents.

What is claimed is:

1. A method of offering a user a good or service within a local region comprising:
allowing a user to select a physical region on a map;
providing the user a list of establishments offering deals within the physical region;
allowing a user to offer a price for a predetermined local deal offered at the establishments;
notifying the establishments in real-time of the offered price for the predetermined local deal; and
an establishment accepting the user's offered price for the predetermined local deal.
